(19) United States
(12) Patent Application Publication
(10) Pub. No.: US 2006/0251287 A1
(43) Pub. Date: Nov. 9, 2006

(54) Sheet identifying device and method

(76) Inventors: Satoru Tsurumaki, Saitama (JP); Seiji Takamatsu, Saitama (JP); Yasuyuki Kimura, Saitama (JP)

Correspondence Address: FISH & RICHARDSON P.C., P.O. BOX 1022, MINNEAPOLIS, MN, 55440-1022, US

(21) Appl. No.: 10/554,255

(22) PCT Filed: Apr. 23, 2004
(86) PCT No.: PCT/JP04/05943

§ 371 Date: Oct. 24, 2005

(30) Foreign Application Priority Data
Apr. 25, 2003 (JP) 2003-121836

(51) Int. Cl. G06K 9/00

(52) U.S. Cl. 382/100

(57) ABSTRACT

A sheet identifying device and method for identifying the kind of sheet or checking a sheet correctly by reducing the adverse influence of the wrinkle and stain of the sheet and of the displacement of a watermark pattern from the watermark area. A transmission optical sensor (8) images a sheet. A watermark area extracting section (12) extracts image data on a watermark area. A watermark area gravity center calculating section (13) calculates the center of gravity of the watermark area. A watermark pattern displacement calculating section (14) calculates the displacement of the watermark pattern from the center of gravity. An identification object image extracting section (15) extracts identification object image data with reference to the displacement. A scratch/stain detecting section (7) calculates the difference between the identification image data and a true template to extract an image of a scratch and stain. A pattern matching section (19) conducts pattern matching between the identification object image data corrected about the influence of the scratch and stain and the true template to identify the kind of sheet and check it.

### TECHNICAL FIELD

The present invention relates to a sheet identifying device and method, and in particular to a sheet identifying device and method for determining the kind and authenticity of a sheet by extracting feature of the sheet.

### BACKGROUND ART

Typically, the kind or authenticity of a sheet such as a currency note, a check, or a voucher inserted by a user is identified by using a magnetic or an optical sensor which magnetically or optically extracts feature of the sheet

When extracting feature of a sheet with an optical sensor, a transmission optical sensor or a reflecting optical sensor is used to extract patterns, dimensions, and orientation of the sheet to obtain an image pattern, and the image pattern thus obtained is matched against a standard pattern of an authentic sheet prepared for each kind of sheets, whereby the kind and authenticity of the inserted sheet are identified.

Particularly, when a transmission optical sensor is used to identify the kind and authenticity of a sheet, a light-emitting device and a light-receiving device are spaced apart with a predetermined distance, and a specific pattern is detected from the sheet while the sheet is conveyed between the light-emitting device and the light-receiving device. The detected specific pattern is then matched against a standard specific pattern of an authentic sheet that has been previously stored to identify the kind and authenticity of the inserted sheet.

The specific pattern may be a watermark pattern, for example. One of conventional methods of detecting a watermark pattern is disclosed, for example, in Japanese Patent Laid-Open Publication No. 2002-33912. According to this conventional method, an image of a watermark area including a watermark pattern is binarized, and the binarized image data is projected in an arbitrary direction to determine whether a watermark pattern is included or not.

FIGS. 8(a) and 8(b) are diagrams schematically illustrating a conventional method of detecting a watermark pattern 23.

FIG. 8(a) is a diagram schematically illustrating a conventional method of detecting the watermark pattern 23 when the sheet has no wrinkles or stains. When a watermark area 21 as shown in FIG. 8(a) is binarized, the binarized image data is composed of white pixels (with a pixel value of “0”) representing the watermark area 21 and black pixels (with a pixel value of “1”) representing the watermark patterns 23. The number of black pixels in the image data is projected in the X direction, whereby a graph 341 as shown in FIG. 8(a) is generated. The number of black pixels in a relevant part of the Y-coordinate is detected from the graph 341 to determine whether a watermark pattern 23 is present or not.

FIG. 8(b) is a diagram schematically illustrating a method of detecting a watermark pattern 23 when a sheet has wrinkles or stains. When a watermark area 21 as shown in FIG. 8(a) is binarized, the binarized image data is composed of white pixels (with a pixel value of “0”) representing the watermark area 21, and black pixels (with a pixel value of “1”) representing the watermark patterns 23 and the wrinkles and stains (331, 332, 333). The number of black pixels in the image data is projected in the X direction, whereby a graph 342 as shown in FIG. 8(b) is generated. However, this graph 342 is affected by the wrinkles and stains (331, 332, and 333) so significantly that the presence of the watermark patterns 23 may be determined erroneously.

Thus, according to the conventional methods of detecting watermark patterns, the detection result is apt to be affected by wrinkles, stains and other conditions of a sheet, which makes it difficult to determine the kind or authenticity of the sheet correctly.

Additionally, according to the conventional methods of detecting watermark patterns, the detection result is apt to be affected also by displacement of the watermark patterns relative to the watermark area, which makes it difficult to determine the kind or authenticity of the sheet correctly.

### DISCLOSURE OF THE INVENTION

It is therefore an object of the present invention to provide a sheet identifying device and method which is capable of determining the kind or authenticity of a sheet by reducing the adverse influence of wrinkles and stains of the sheet and adverse influence of displacement of a watermark pattern relative to the watermark area.

To achieve the above objection, according to the invention of claim 1, a sheet identifying device comprises a transmission optical sensor which emits transmission light to a sheet to obtain an image of the sheet based on the transmission light; watermark area extracting means for extracting an image of a watermark area where a watermark pattern is present, from the image obtained by the transmission optical sensor; identification object image data extracting means for extracting identification object image data that is used as an object of identification in identifying the sheet, from the watermark area extracted by the watermark area extracting means; unnecessary image detecting means for detecting an unnecessary image in the identification object image data extracted by the identification object image data extracting means; and sheet identifying means for identifying the sheet based on the identification object image data and the unnecessary image detected by the unnecessary image detecting means.

According to the invention of claim 2, in the invention of claim 1, the identification object image data extracting means comprises watermark pattern displacement calculating means for calculating a displacement of the watermark pattern relative to the watermark area extracted by the watermark area extracting means, whereby the identification object image data is extracted from the watermark area based on the displacement calculated by the watermark pattern displacement calculating means.

According to the invention of claim 3, in the invention of claim 2, the watermark pattern displacement calculating means comprises watermark area information calculating means for calculating watermark area information of the watermark area extracted by the watermark area extracting means; and watermark area gravity center calculating means for calculating center of gravity of the watermark area based on the watermark area information calculated by the watermark area information calculating means, whereby the displacement of the watermark pattern is calculated based on the center of gravity of the watermark area calculated by the watermark area gravity center calculating means.

According to the invention of claim 4, in the invention of claim 3, the sheet identifying means identifies the sheet based on the watermark area information calculated by the watermark area information calculating means.

According to the invention of claim 5, in the invention of claim 3, the watermark area information comprises area, degree of circularity, and length of circumference of the watermark area.

According to the invention of claim 6, in the invention of claim 1, the unnecessary image detecting means comprises difference calculating means for calculating a difference between the identification object image data extracted by the identification object image data extracting means and a template that has previously been obtained from an authentic sheet, whereby an unnecessary image in the identification object image data is detected based on the difference calculated by the difference calculating means.

According to the invention of claim 7, in the invention of claim 6, the sheet identifying means identifies the sheet based on the difference calculated by the unnecessary image detecting means.

According to the invention of claim 8, in the invention of claim 1, the sheet identifying means identifies the sheet by comparing the identification object image data corrected for the unnecessary image detected by the unnecessary image detecting means with the template.

According to the invention of claim 9, a sheet identifying method comprises irradiating transmission light to a sheet; obtaining an image of the sheet based on the transmission light; extracting an image of a watermark area where a watermark pattern is present, from the obtained image; extracting identification object image data that is used as an identification object in identifying the sheet, from the extracted watermark area; detecting an unnecessary image in the extracted identification object image data; and identifying the sheet based on the detected unnecessary image and the identification object image data.

According to the invention of claim 10, the invention of claim 9 further comprises calculating a displacement of the watermark pattern relative to the watermark area; and extracting the identification object image data from the watermark area based on the displacement thus calculated.

According to the invention of claim 11, the invention of claim 10 further comprises calculating watermark area information of the watermark area; calculating center of gravity of the watermark area based on the watermark area information thus calculated; and calculating the displacement of the watermark pattern based on the center of gravity of the watermark area thus calculated.

According to the invention of claim 12, in the invention of claim 11, the sheet is identified based on the watermark area information.

According to the invention of claim 13, in the invention of claim 11, the watermark area information comprises area, degree of circularity, and length of circumference of the watermark area.

According to the invention of claim 14, the invention of claim 9 further comprises calculating difference between the identification object image data and a template that is previously obtained from an authentic sheet; and detecting an unnecessary image in the identification object image data based on the difference thus calculated.

According to the invention of claim 15, in the invention of claim 14, the sheet is identified based on the difference.

According to the invention of claim 16, in the invention of claim 9, the sheet is identified by comparing the identification object image data corrected for the unnecessary image with the template.

### BRIEF DESCRIPTION OF THE DRAWINGS

FIG. 1 is a block diagram illustrating an example of a functional configuration of a sheet identifying device 1 according to the present invention;

FIG. 2 is a block diagram illustrating an example of a functional configuration of an identifying section 7;

FIG. 3 is a flowchart illustrating the processing procedures performed by the sheet identifying device 1 for identifying the kind and authenticity of an inserted sheet;

FIGS. 4(a) through 4(c) are diagrams illustrating processing of image data 20 of an image pickup area of a sheet performed by the identifying section 7;

FIGS. 5(a) and 5(b) are diagrams illustrating processing of image data 24 of a watermark area of a sheet performed by the identifying section 7;

FIG. 6 is diagram illustrating processing performed by a scratch/stain detecting section 17 to detect images 30 indicating scratches and stains present in an identification object image data 28;

FIGS. 7(a) and 7(b) are diagrams illustrating processing for identifying a sheet based on differential image data between an identification object image data 28 and an authentic template 29; and

FIGS. 8(a) and 8(b) are diagrams schematically illustrating a conventional method of detecting watermark patterns 23.

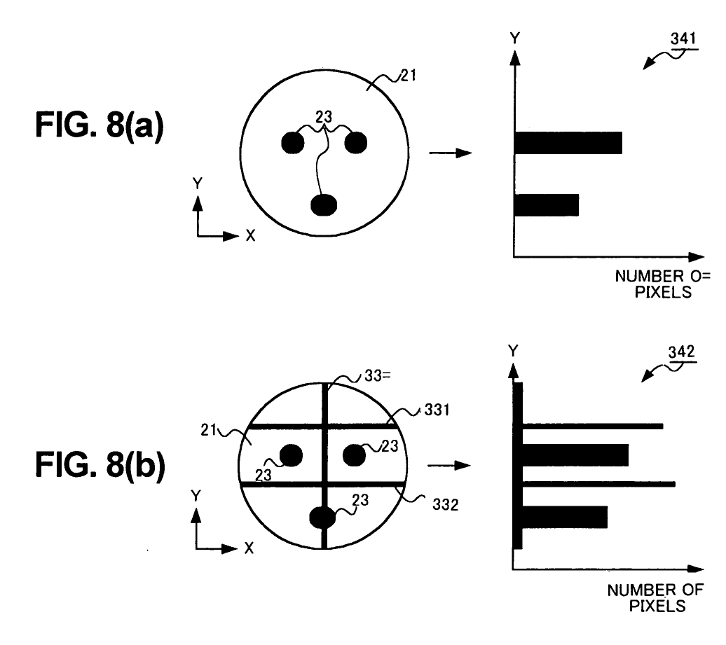

### BEST MODE FOR CARRYING OUT THE INVENTION

An embodiment of a sheet identifying device and method according to the present invention will be described in detail with reference to the accompanying drawings.

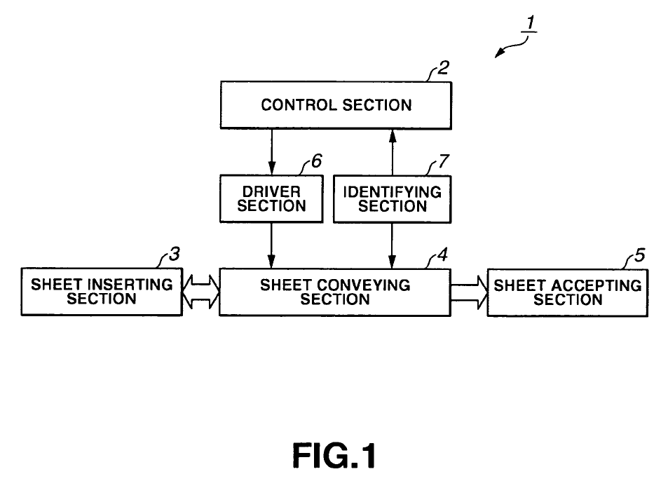

FIG. 1 is a block diagram illustrating an example of a functional configuration of a sheet identifying device 1 according to the present invention.

As shown in FIG. 1, the sheet identifying device 1 includes a control section 2 for controlling the whole of sheet identifying device 1, a sheet inserting section 3 being an opening for inserting a sheet, a sheet conveying section 4 for conveying a sheet, a sheet accepting section 5 for accepting a sheet, a driver section 6 for driving the sheet conveying section 4 according to control of the control section 2, and an identifying section 7 for identifying the kind and authenticity of a sheet.

A description will now be made of a functional operation performed by the sheet identifying device 1 to identify the kind and authenticity of a sheet inserted into the device.

When a sheet is inserted through the sheet inserting section 3, the control section 2 controls the driver section 6 to convey the sheet by means of the sheet conveying section 4. The identifying section 7 identifies the kind and authenticity of the sheet which is being conveyed by the sheet conveying section 4. If the identifying section 7 determines that the sheet is authentic, the control section 2 then controls the driver section 6 to drive the sheet conveying section 4 to convey the sheet to the sheet accepting section 5, which accepts the authentic sheet. In contrast, if the identifying section 7 determines that the sheet is false, the control section 2 controls the driver section 6 to drive the sheet conveying section 4 to convey the sheet to the sheet inserting section 3, which returns the false sheet.

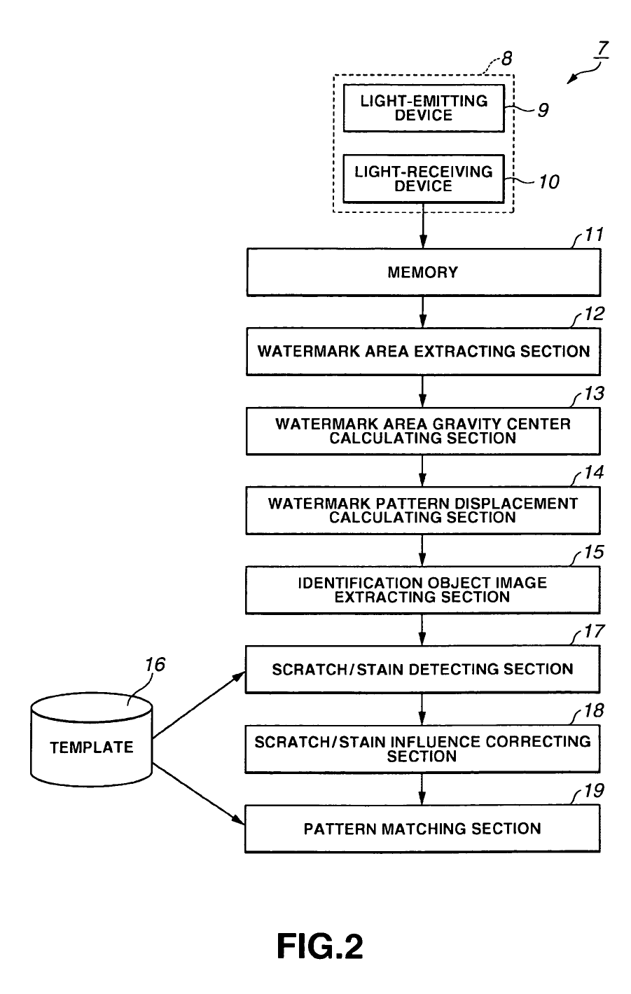

FIG. 2 is a block diagram illustrating an example of a functional configuration of the identifying section 7.

As shown in FIG. 2, the identifying section 7 includes a transmission optical sensor 8, a memory 11, a watermark area extracting section 12, a watermark area gravity center calculating section 13, a watermark pattern displacement calculating section 14, an identification object image extracting section 15, a template 16, a scratch/stain detecting section 17, a scratch/stain influence correcting section 18, and a pattern matching section 19.

The transmission optical sensor 8 is composed of a pair of a light-emitting device 9 and a light-receiving device 10 which are arranged to interpose the sheet conveying section 4 therebetween. The transmission optical sensor 8 is arranged on a predetermined scanning line passing through an image pickup area including a watermark area of a sheet to be identified, so that the light-emitting device 9 emits light to the image pickup area of the sheet conveyed by the sheet conveying section 4, and the light-receiving device 10 receives light that has been transmitted through the image pickup area of the sheet, and outputs an electric signal according to the quantity of transmission light thus received. Any of infrared light, ultraviolet light, and visible light is applicable to the transmission optical sensor 8.

The memory 11 sequentially stores signals levels of electric signals outputted from the transmission optical sensor 8 at predetermined time intervals in a predetermined storage area, while assigning consecutive addresses thereto, and temporarily stores and holds them as image data of the image pickup area of the sheet.

The watermark area extracting section 12 retrieves the image data of the image pickup area of the sheet stored and held by the memory 11, and extracts image data of a watermark area included in the image pickup area.

The watermark area gravity center calculating section 13 calculates the circumference, the degree of circularity, and the area of the watermark area based on the image data of the watermark area extracted by the watermark area extracting section 12, and then calculates the center of gravity of the watermark area based on the circumference, the degree of circularity, and the area of the watermark area obtained by the calculation.

The watermark pattern displacement calculating section 14 calculates the displacement of the watermark pattern relative to the watermark area, based on the center of gravity of the watermark area calculated by the watermark area gravity center calculating section 13. The calculation of the displacement of the watermark pattern is carried out by detecting a featuring point of the watermark pattern from the graph in which the image data of the watermark area is projected in the X and Y directions, and calculating the displacement of the watermark pattern based on the positional relationship between the detected featuring points of the watermark pattern and the center of gravity of the watermark area. The position of the pixel to be projected should be selected so as to be a position that is stable even if a scratch or stain that is prone to be picked up as a feature is present. Further, in order to prevent erroneous calculation due to such scratch or stain, it is also possible to perform projection at a plurality of points.

The identification object image extracting section 15 extracts identification object image data that is used as an identification object when identifying the sheet, based on the displacement of the watermark pattern calculated by the watermark pattern displacement calculating section 14.

The template 16 previously accumulates image data obtained from an authentic sheet as an authentic template.

The scratch/stain detecting section 17 calculates the difference between the authentic template and the identification object image data extracted by the identification object image extracting section 15 to detect an image indicating a scratch or stain on the sheet (or a scratch or stain on the transmission optical sensor) that is contained in the identification object image data. An example of the detection equations for detecting a scratch or stain is given below.

$$d = {\sum }_{j = 0}^{N - 1} {\sum }_{i = 0}^{M - 1} \{ ( temp [ i , j ] - t ) - ( f [ i , j ] - f ) \} \qquad ( 1 )$$

In the equation (1), f[i,j] denotes identification object image data, f is an average value of f[i,j], temp[i,j] denotes an authentic template, and t is an average value of temp[i,j]. If d thus obtained is larger than zero, the relevant pixel is determined to be a dark pixel due to a scratch or stain. Whereas, if d is smaller than zero, the relevant pixel is determined to be a bright pixel. Thus, a scratch and stain is detected based on a predetermined threshold value.

The scratch/stain influence correcting section 18 corrects the influence of the image indicating the scratch or stain detected by the scratch/stain detecting section 17. Specifically, the influence may be corrected by erasing the image indicating the scratch or stain from the identification object image data. In this case, however, the image of the watermark pattern may possibly be erased together with the image indicating the scratch or stain, which may lead to erroneous identification. Therefore, it is more preferable to correct the influence by pasting the image indicating the scratch or stain contained in the identification object image data into the authentic template at the same position and with the same area. However, if the influence of all the images indicating the scratches and stains is corrected completely, it will pose a problem that even a false sheet having no watermark pattern is erroneously identified as authentic by correcting the influence. Therefore, the total number of pixels for which the influence can be corrected may be limited.

The pattern matching section 19 identifies the kind and authenticity of the sheet by performing pattern matching between the authentic template and the identification object image data that has been corrected for the influence of the image indicating the scratch or stain by the scratch/stain influence correcting section 18. An example of the equations used for performing the pattern matching is given below.

$$R = \frac{{\sum }_{j = 0}^{N - 1} {\sum }_{i = 0}^{M - 1} ( temp [ i , j ] - t ) ( f [ i , j ] - f )}{\sqrt{{\sum }_{j = 0}^{N - 1} {\sum }_{i = 0}^{M - 1} {( temp [ i , j ] - t )}^{2} \sqrt{{\sum }_{j = 0}^{N - 1} {\sum }_{i = 0}^{M - 1} {( f [ i , j ] - f )}^{2}}}} \qquad ( 2 )$$

When the correlation coefficient R is one, it is determined that the identification object image data is identical to the authentic template, and hence the identified sheet is determined authentic.

A description will now be made of a functional operation performed by the identifying section 7 for identifying the kind and authenticity of an inserted sheet.

A sheet inserted through the sheet inserting section 3 is conveyed by the sheet conveying section 4 to reach a placement position in the transmission optical sensor 8. Thereupon, the light-emitting device 9 emits light to the image pickup area of the sheet. The light-receiving device 10 receives the light transmitted through the image pickup area of the sheet, and output to the memory 11 an electric signal according to the quantity of the transmission light received. Receiving the electric signal, the memory 11 temporarily stores and holds the signal level of the received electric signal as image data of the image pickup area. The watermark area extracting section 12 retrieves the image data stored and held in the memory 11, extracts image data of a watermark area included in the image pickup area, and transmits the extracted image data of the watermark area to the watermark area gravity center calculating section 13. Receiving the image data of the watermark area, the watermark area gravity center calculating section 13 calculates the center of gravity of the watermark area. The watermark pattern displacement calculating section 14 calculates the displacement of a watermark pattern relative to the watermark area based on the center of gravity of the watermark area calculated by the watermark area gravity center calculating section 13. The identification object image extracting section 15 extracts identification object image data that is used as an object of identification when identifying the sheet, based on the displacement of the watermark pattern calculated by the watermark pattern displacement calculating section 14, and transmits the extracted identification object image data to the scratch/stain detecting section 17. Upon receipt of the identification object image data, the scratch/stain detecting section 17 retrieves an authentic template from the template 16 to calculate the difference between the authentic template and the identification object image data, and thereby detects an image indicating a scratch or stain included in the identification object image data. The scratch/stain influence correcting section 18 corrects the influence of the image indicating the scratch or stain detected by the scratch/stain detecting section 17. The pattern matching section 19 identifies the kind and authenticity of the sheet by performing pattern matching between the authentic template and the identification object image data that has been corrected for the influence of the image indicating the scratch or stain by the scratch/stain influence correcting section 18.

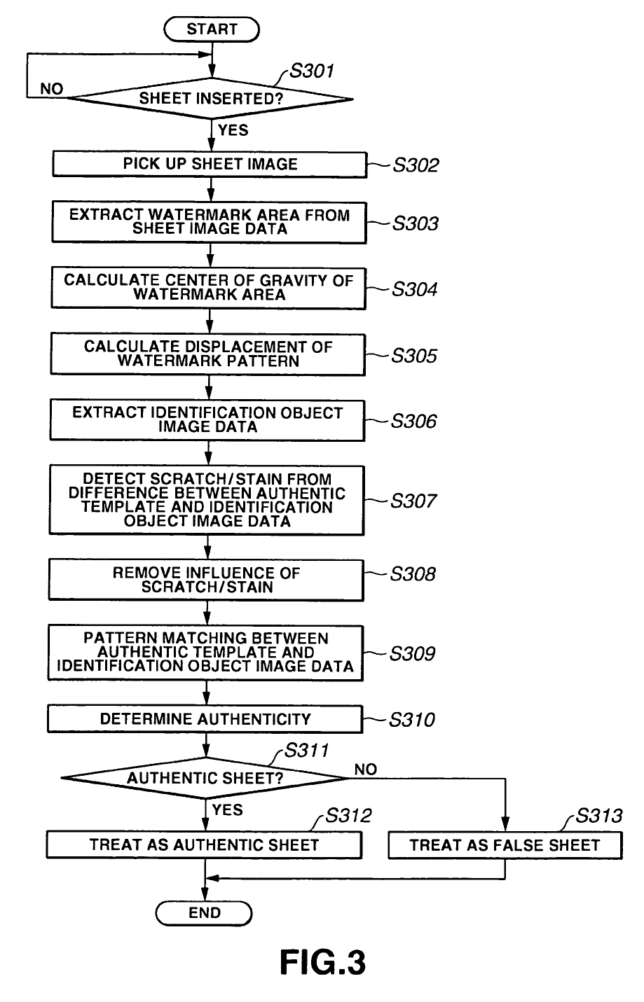

A description will now be made, with reference to the flowchart of FIG. 3, of the processing procedures implemented by the sheet identifying device 1 when identifying the kind and authenticity of an inserted sheet.

When a sheet is inserted through the sheet inserting section (YES in step S301) the sheet identifying device picks up an image of the sheet by means of the transmission optical sensor (step S302), and extracts a watermark area from the image data of the sheet (step S303). The sheet identifying device then calculates the center of gravity of the watermark area based on the image data of the extracted watermark area (step S304), and calculates the displacement of the watermark pattern relative to the watermark area based on the center of gravity of the watermark area thus calculated (step S305). The sheet identifying device then extracts identification object image data based on the displacement of the watermark pattern obtained by the calculation (step S306), and calculates the difference between the authentic template and the extracted identification object image data to detect an image indicating a scratch or stain contained in the identification object image data (step S307). The sheet identifying device corrects the influence of the image indicating the scratch or stain thus detected (step S308), performs pattern matching between the authentic template and the identification object image data corrected for the influence of the image indicating the scratch or stain (step S309), and determines the authenticity of the sheet based on the pattern matching (step S310). If it is determined that the sheet is authentic (YES in step S311), the sheet identifying device accepts the sheet in the sheet accepting section (step S312), and completes the processing.

In contrast, if the sheet is determined to be false in step S311 (NO in step S311), the sheet identifying device returns the sheet from the sheet inserting section (step S313), and completes the processing.

A detailed description will now be made of a sheet identifying method performed by the identifying section 7 according to the present invention.

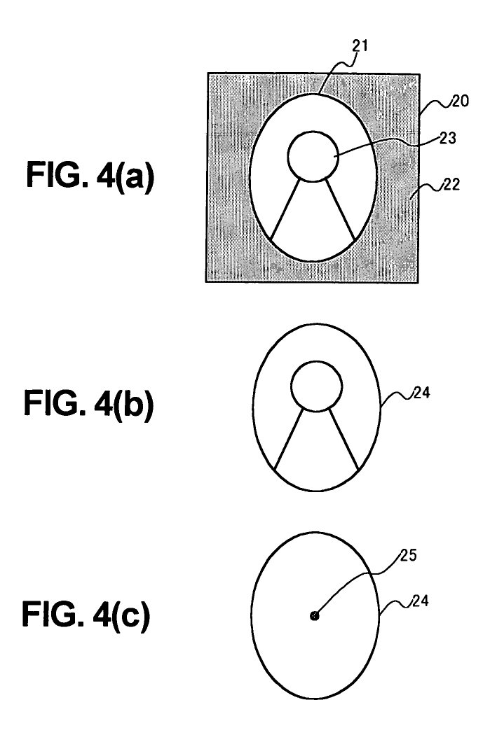

FIGS. 4(a) through 4(c) are diagrams illustrating the processing of image data 20 of an image pickup area of a sheet performed by the identifying section 7.

FIG. 4(a) shows an example of image data 20 of the image pickup area of the sheet that is picked up by the transmission optical sensor 8. As shown in FIG. 4(a), as a result of the fact that the light-receiving device 10 has received transmission light transmitted through a watermark area 21 of the sheet, the image pickup area of the sheet includes the watermark area 21 together with an unmarked area 22 other than the watermark area, and the watermark area includes a watermark pattern 23 in. The quantity of light transmitted through the watermark area 21 is large, while the quantity of light transmitted through the watermark pattern 23 is smaller than the quantity of light transmitted through the watermark area 21. The quantity of light transmitted through the unmarked area 22 is smaller than the quantity of light transmitted through the watermark pattern 23.

The image data 20 of the image pickup area of the sheet is binarized to discriminate between the watermark area 21 and the unmarked area 22, and image data 24 of the watermark area is extracted from the image data 20 of the image pickup area of the sheet, as shown in FIG. 4(b).

The circumference, the degree of circularity, and the area of the watermark area 21 are calculated on the basis of the image data 24 of the watermark area. As shown in FIG. 4(c), the center of gravity 25 of the watermark area is then calculated on the basis of the circumference, the degree of circularity, and the area of the watermark area 21.

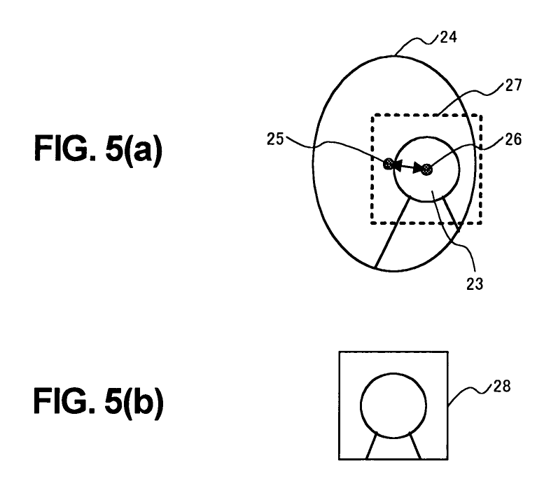

FIGS. 5(a) and 5(b) are diagrams illustrating the processing of the image data 24 of the watermark area of the sheet performed by the identifying section 7.

As shown in FIG. 5(a), upon the center of gravity 25 of the watermark area being calculated, a featuring point 26 of the watermark pattern is detected. The displacement of the watermark pattern 23 relative to the watermark area 21 is then calculated on the basis of the positional relationship between the featuring point 26 of the watermark pattern and the center of gravity 25 of the watermark area. An identification object range 27 for identifying the sheet is detected on the basis of the displacement of the watermark pattern 23 obtained by the calculation.

As shown in FIG. 5(b), identification object image data 28 is extracted from the image data 24 of the watermark area on the basis of the identification object range 27 for identifying the sheet.

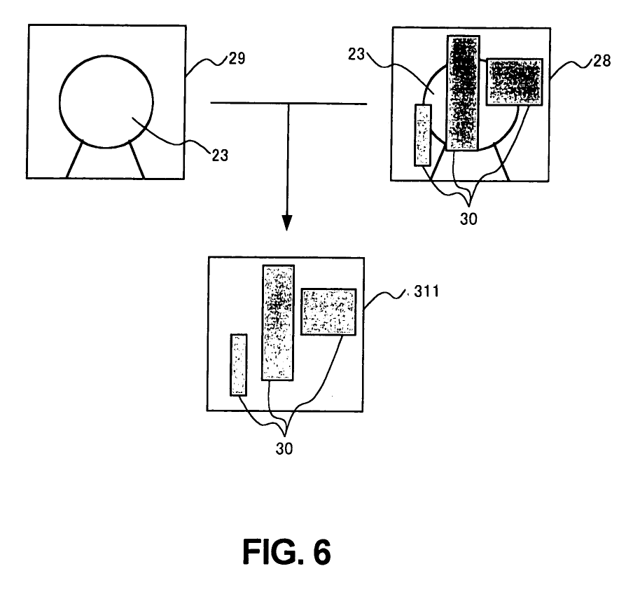

FIG. 6 is diagrams illustrating the processing performed by the scratch/stain detecting section 17 to detect an image 30 indicating a scratch or stain included in the identification object image data 28.

If the sheet has a scratch or stain, or the transmission optical sensor 8 has a scratch or stain, such scratch or stain will block light from the light-emitting device 9 when picking up an image of the sheet, resulting in that an unnecessary image of the scratch or stain will be included in the image of the image pickup area of the sheet obtained by the light-receiving device 10. In particular, if the scratch or stain is present in the watermark area 21 of the sheet, or if the scratch or stain is present at such a position in the transmission optical sensor 8 as to block the transmission light transmitted through the watermark area 21, the identification object image data will inevitably include the image indicating the scratch or stain.

Therefore, as shown in FIG. 6, the difference between an authentic template 29 previously obtained from an authentic sheet and the identification object image data including the image 30 indicating the scratch or stain is calculated. The authentic template 29 and the identification object image data 28 commonly have the image of the watermark pattern 23, whereas the image that is not common between them is the image 30 of the scratch or stain included in the identification object image data 28. Accordingly, differential image data 311 indicating the difference between the authentic template 29 and the identification object image data 28 contains only the image 30 of the scratch or stain. Thus, the image 30 indicating the scratch or stain can be detected from the differential image data 311.

The influence of the detected image 30 indicating the scratch or stain is corrected, and the corrected identification object image data 28 is subjected to pattern matching with the authentic template 29 to identify the kind and authenticity of the sheet.

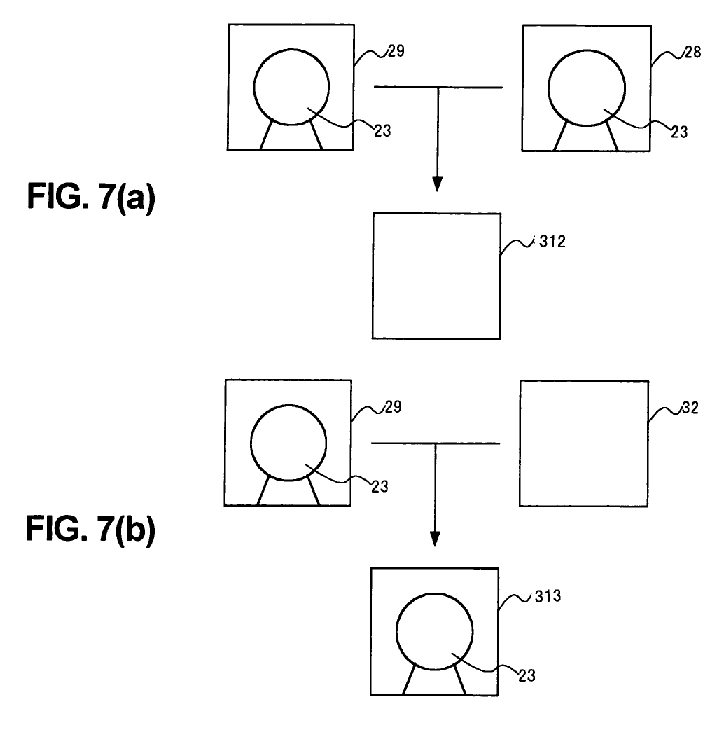

FIGS. 7(a) and 7(b) are diagrams illustrating the processing for identifying the sheet based on the differential image data between the identification object image data 28 and the authentic template 29.

For example, when there is no image 30 indicating a scratch or stain in the identification object image data 28 extracted from the image data of the image pickup area of an authentic sheet, all the pixels in differential image data 312 will be “white” as shown in FIG. 7(a). In this case, the relevant sheet can be identified as authentic by acknowledging that all the pixels of the differential image data 312 are “white”. However, in reality, the identification object image data 28 is believed to inevitably contain an image 30 indicating some sort of scratch or stain. Therefore, sheet-less image data may be previously generated by the transmission optical sensor 8 and registered as a template, and the image data 312 may be subjected to pattern matching with the registered sheet-less image data to identify the kind and authenticity of the sheet.

All the pixels in the identification object image data 32 extracted from the image data of the image pickup area of a false sheet having no watermark area 21 will be “white”. As shown in FIG. 7(b), in differential image data 313 between the identification object image data 32 and the authentic template 29, only the pixels of the image of the watermark pattern 23 will be “black”. Therefore, the relevant sheet can be identified as false by performing pattern matching between the differential image data 313 and the authentic template 29 to acknowledge that the differential image data 313 coincides with the authentic template 29.

It is possible to utilize the fact different sheets have different shapes of watermark areas 21. For example, when a sheet with a watermark area 21 of a circular or elliptical shape is to be identified, the kind and authenticity of the sheet can be identified based on the circumference, the degree of circularity, and the area of the watermark area 21 calculated from the image data 24 of the watermark area.

When identifying a sheet having a watermark area 21 displaced from the center in the lateral direction, the direction in which the sheet is inserted can be determined on the basis of the center of gravity 25 of the watermark area calculated from the image data 24 of the watermark area. This makes it possible to alleviate the processing load of identifying the kind and authenticity of the sheet.

In practice, the kind and authenticity of a sheet need not be identified only by the sheet identifying method according to the present invention. Instead, a final conclusion of identification of the sheet may be made in combination with other identification factors.

### INDUSTRIAL APPLICABILITY

According to the present invention, the displacement of a watermark pattern relative to a watermark area of a sheet is calculated, and identification object image data of a correct range is extracted based on the displacement thus calculated. This makes it possible to reduce the influence of displacement of the watermark pattern by calculating. Additionally, according to the present invention, an unnecessary image indicating a scratch or stain is detected from differential image data between the identification object image data and the authentic template, and pattern matching is performed between the authentic template and the identification object image data corrected for the influence of the detected unnecessary image. This makes it possible to reduce the influence of wrinkles and stains in the sheet. Thus, the present invention enables correct identification of the kind and authenticity of a sheet.

1. A sheet identifying device comprising:
a transmission optical sensor which emits transmission light to a sheet to obtain an image of the sheet based on the transmission light;
watermark area extracting means for extracting an image of a watermark area where a watermark pattern is present, from the image obtained by the transmission optical sensor;
identification object image data extracting means for extracting identification object image data that is used as an object of identification in identifying the sheet, from the watermark area extracted by the watermark area extracting means;
unnecessary image detecting means for detecting an unnecessary image in the identification object image data extracted by the identification object image data extracting means; and
sheet identifying means for identifying the sheet based on the identification object image data and the unnecessary image detected by the unnecessary image detecting means.

2. The sheet identifying device according to claim 1, wherein the identification object image data extracting means comprises watermark pattern displacement calculating means for calculating a displacement of the watermark pattern relative to the watermark area extracted by the watermark area extracting means,
whereby the identification object image data is extracted from the watermark area based on the displacement calculated by the watermark pattern displacement calculating means.

3. The sheet identifying device according to claim 2, wherein the watermark pattern displacement calculating means comprises:
watermark area information calculating means for calculating watermark area information of the watermark area extracted by the watermark area extracting means; and
watermark area gravity center calculating means for calculating center of gravity of the watermark area based on the watermark area information calculated by the watermark area information calculating means,
whereby the displacement of the watermark pattern is calculated based on the center of gravity of the watermark area calculated by the watermark area gravity center calculating means.

4. The sheet identifying device according to claim 3, wherein the sheet identifying means identifies the sheet based on the watermark area information calculated by the watermark area information calculating means.

5. The sheet identifying device according to claim 3, wherein the watermark area information comprises area, degree of circularity, and length of circumference of the watermark area.

6. The sheet identifying device according to claim 1, wherein the unnecessary image detecting means comprises difference calculating means for calculating a difference between the identification object image data extracted by the identification object image data extracting means and a template that has previously been obtained from an authentic sheet,
whereby an unnecessary image in the identification object image data is detected based on the difference calculated by the difference calculating means.

7. The sheet identifying device according to claim 6, wherein the sheet identifying means identifies the sheet based on the difference calculated by the unnecessary image detecting means.

8. The sheet identifying device according to claim 1, wherein the sheet identifying means identifies the sheet by comparing the identification object image data corrected for the unnecessary image detected by the unnecessary image detecting means with the template.

9. A sheet identifying method comprising:
irradiating transmission light to a sheet;
obtaining an image of the sheet based on the transmission light;
extracting an image of a watermark area where a watermark pattern is present, from the obtained image;
extracting identification object image data that is used as an identification object in identifying the sheet, from the extracted watermark area;
detecting an unnecessary image in the extracted identification object image data; and
identifying the sheet based on the detected unnecessary image and the identification object image data.

10. The sheet identifying method according to claim 9, further comprising:
calculating a displacement of the watermark pattern relative to the watermark area; and
extracting the identification object image data from the watermark area based on the displacement thus calculated.

11. The sheet identifying method according to claim 10, further comprising:
calculating watermark area information of the watermark area;
calculating center of gravity of the watermark area based on the watermark area information thus calculated; and
calculating the displacement of the watermark pattern based on the center of gravity of the watermark area thus calculated.

12. The sheet identifying method according to claim 11, wherein the sheet is identified based on the watermark area information.

13. The sheet identifying method according to claim 11, wherein the watermark area information comprises area, degree of circularity, and length of circumference of the watermark area.

14. The sheet identifying method according to claim 9, further comprising:
calculating difference between the identification object image data and a template that is previously obtained from an authentic sheet; and
detecting an unnecessary image in the identification object image data based on the difference thus calculated.

15. The sheet identifying method according to claim 14, wherein the sheet is identified based on the difference.

16. The sheet identifying method according to claim 9, wherein the sheet is identified by comparing the identification object image data corrected for the unnecessary image with the template.
